(19) United States
(12) Patent Application Publication
(10) Pub. No.: US 2009/0205256 A1
(43) Pub. Date: Aug. 20, 2009

(54) Pneumatic car trunk opener

(76) Inventor: Guy Valois, Laval (CA)

Correspondence Address: INVENTARIUM;SUITE 1607, 4050 ROSEMONT, MONTREAL, QC, H1X1M4, CA

(21) Appl. No.: 12/033,096

(22) Filed: Feb. 19, 2008

(51) Int. Cl. E05F 15/02

(52) U.S. Cl. 49/137; 701/49

(57) ABSTRACT

A pneumatic car trunk opener has an electric compressor, an air tank, a regulator, three way solenoids to control air flow, and a pneumatic piston. The pneumatic piston is fed air via a hose from an air exit porthole and when the piston is retracted, it pulls on an attachment bracket which opens a lid and when it is protracted, it pushes on the attachment bracket which closes the lid.

### FIELD OF THE INVENTION

The present invention relates generally to automotive accessories but more particularly to an opener for car trunks.

### BACKGROUND OF THE INVENTION

There exist several systems using remote control to automatically open the trunk of cars. Most are factory installed. There is a need for a car trunk opener that can be quickly installed by an unskilled end user in an existing car.

### SUMMARY OF THE INVENTION

In view of the lack of a suitable car trunk opener that can be quickly installed by an unskilled end user in an existing car, the present invention, which will be described subsequently in greater detail, is to provide objects and advantages which are:

To provide for an easy to install automatic trunk opener.

To provide for an automatic trunk opener using pneumatic force.

To provide for an automatic trunk opener which pulls on the trunk lid hinge in order to open the trunk.

To attain these ends, the present invention generally comprises a compressor to compress air which then travels via compressor hose and enter into one end of an air tank. At the opposite end of the air tank, is a regulator which is connected to the air tank by way of a pneumatic adapter. The regulator regulates the air pressure which distributes the air by way of solenoid hoses leading to the solenoids by way of pneumatic couplers.

The piston hoses leaving the solenoids go to the piston wherein one piston hose connecting to one extremity of the piston controls the protraction of the piston while another hose connecting to the opposite extremity of the piston controls the retraction of the piston.

The piston has two points of attachments with one point of attachment being the lid attachment bracket which attaches the piston to a component of the trunk lid, and the other point of attachment being a body attachment bracket which connects the piston to the body of a car. The lid attachment bracket and the body attachment bracket being rotationally attached to the piston.

Optionally, a pressure gauge can be connected to the regulator monitors air pressure in the air tank. Also, the solenoids are controlled by a microprocessor which interprets the signal sent from a user by way of a remote controller.

The pneumatic car trunk opener has a method of operation which consists in the step of when the piston is retracted, it pulls on a lid attachment bracket which opens a trunk lid. When the piston is protracted, it pushes on the attachment bracket which closes the trunk lid.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Perspective view of the compressor unit.

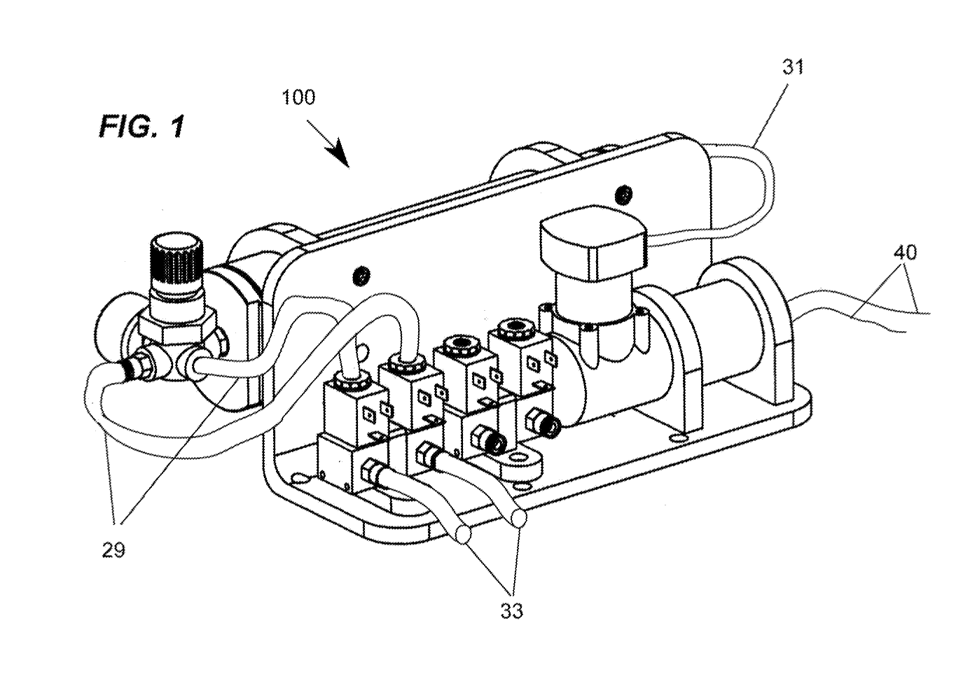

FIG. 2 Exploded view of the compressor unit.

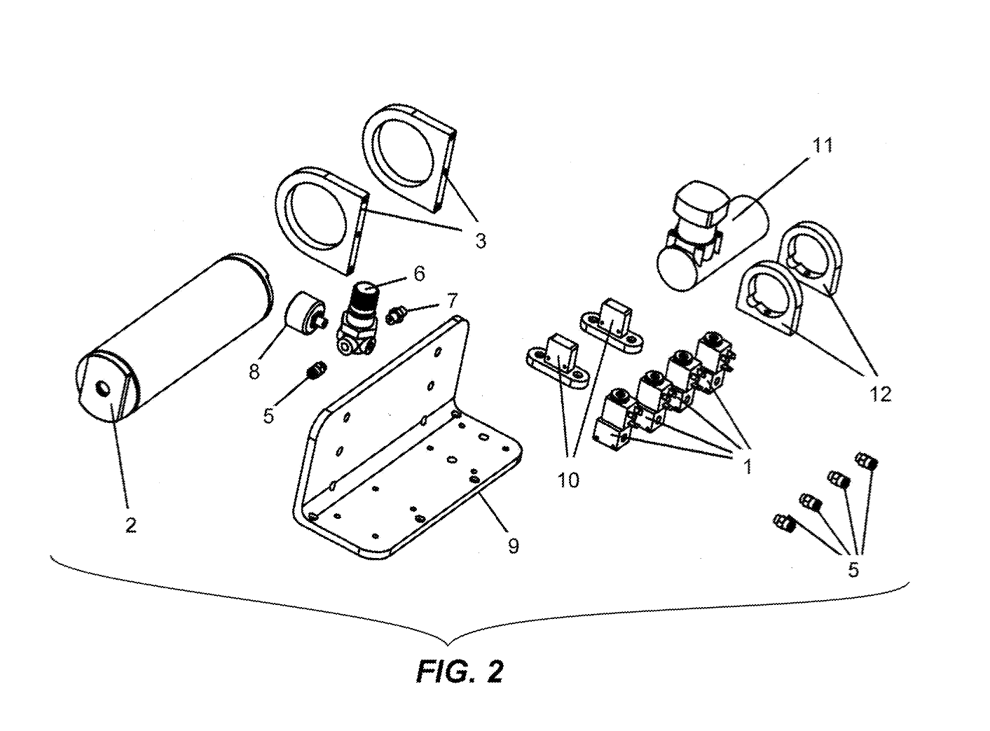

FIG. 3a-b Side view of the lid open and closed respectively.

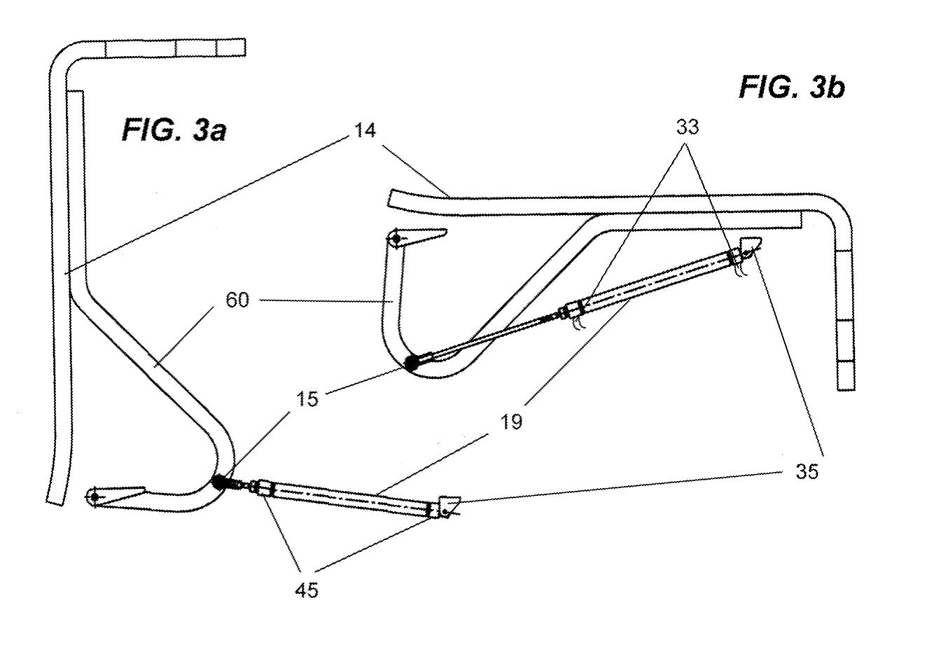

### DETAILED DESCRIPTION

A pneumatic car trunk opener (100) has an electric compressor (11), an air tank (2), a regulator (6), and three way solenoids (1) to control air flow.

A pneumatic piston (19) is fed air via air hoses (33) that enter at each of its extremities (45, 45′).

When the piston (19) is retracted, it pulls on a lid attachment bracket (15) which opens a trunk lid (14). When the piston (19) is protracted, it pushes on the attachment bracket (15) which closes the trunk lid (14).

The piston (19) has two points of attachments. One being the lid attachment bracket (15) which attaches the piston (19) to a component of the trunk lid (14)—in this example the hinge (60) of the lid)—and the other being a body attachment bracket (17) which connects the piston (19) to the body of the car (not shown). Both the lid attachment bracket (15) and the body attachment bracket (17) are rotationally attached to the piston (19).

The compressor (11) compresses air which then travels via compressor hose (31) and enters into one end of the air tank (2). At the opposite end of the air tank (2) is the regulator (6), which is connected to the air tank (2) by way of a pneumatic adapter (7). A pressure gauge (8) can optionally be installed to monitor air pressure in the air tank (2). The regulator (6) regulates the air pressure which distributes the air by way of solenoid hoses (29) leading to the solenoids (1) by way of pneumatic couplers (5). The solenoids (1) are controlled by a microprocessor (not shown) which interprets the signal sent from a user by way of a remote controller.

The piston hoses (29) leaving the solenoids (1) go to the piston (19) One piston hose (29) controls the protraction of the piston (19) while another hose (29) controls the retraction of the piston (19) as described hereinabove.

There exist some car models which already have remote unlocking of the trunk but the lid does not fully open. With this invention, once unlocked, the same signal can then be relayed to the solenoids (1) by way of the microprocessor (not shown) which would distinguish between an opening or closing signal. For car models not having trunk unlocking means, this feature can easily be installed using existing components. Finally, the compressor (11) is powered electrically by way of wires (40).

Other components include air tank mounting brackets (3), main mounting bracket (9), solenoid mounting brackets (10), and compressor mounting brackets (12). The main mounting bracket (90 is used for mounting preferably inside the trunk on a part of the car body (not shown).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A pneumatic car trunk opener comprising:
a compressor to compress air which then travels via compressor hose and enter into one end of an air tank;
at the opposite end of the air tank, is a regulator which is connected to the air tank by way of a pneumatic adapter;
the regulator regulates the air pressure which distributes the air by way of solenoid hoses leading to the solenoids by way of pneumatic couplers;
the piston hoses leaving the solenoids go to the piston wherein one piston hose connecting to one extremity of the piston controls the protraction of the piston while another hose connecting to the opposite extremity of the piston controls the retraction of the piston;
the piston has two points of attachments with one point of attachment being the lid attachment bracket which attaches the piston to a component of the trunk lid, and the other point of attachment being a body attachment bracket which connects the piston to the body of a car;
the lid attachment bracket and the body attachment bracket being rotationally attached to the piston.

2. A pneumatic car trunk opener as in claim 1 wherein: a pressure gauge connected to the regulator monitors air pressure in the air tank.

3. A pneumatic car trunk opener as in claim 1 wherein: the solenoids are controlled by a microprocessor which interprets the signal sent from a user by way of a remote controller.

4. A pneumatic car trunk opener as in claim 1 having the method of operation consisting in the step of:
when the piston is retracted, it pulls on a lid attachment bracket which opens a trunk lid;
when the piston is protracted, it pushes on the attachment bracket which closes the trunk lid.
